(19) United States
(12) Patent Application Publication
(10) Pub. No.: US 2015/0378476 A1
(43) Pub. Date: Dec. 31, 2015

(54) TOUCH DISPLAY DEVICES

(71) Applicant: InnoLux Corporation, Miao-Li County (TW)

(72) Inventors: Li-Wei SUNG, Miao-Li County (TW); Yu-Chien KAO, Miao-Li County (TW); Tsan-Chu LU, Miao-Li County (TW); Yen-Chieh TSENG, Miao-Li County (TW); Chu-Hung TSAI, Miao-Li County (TW)

(21) Appl. No.: 14/741,861

(22) Filed: Jun. 17, 2015

(30) Foreign Application Priority Data
Jun. 27, 2014 (TW) 103122215

(51) Int. Cl. G06F 3/044

(52) U.S. Cl. CPC G06F 3/044

(57) ABSTRACT

A touch display device is provided. The touch display device includes a touch sensing layer formed on a surface of a substrate of a display element. The touch sensing layer includes a plurality of zigzag traces respectively connected to a plurality of electrodes. A plurality of zigzag slits is alternately disposed between the zigzag traces. The zigzag slits overlap a plurality of pixel areas of the display element. The zigzag slits include a first, second and third slits. There are a first and second distances respectively between a turning point of the second slit and nearest adjacent turning points of the first and third slits. The first distance is different form the second distance.

### CROSS REFERENCE TO RELATED APPLICATIONS

This application claims priority of Taiwan Patent Application No. 103122215, filed on. Jun. 27, 2014, the entirety of which is incorporated by reference herein.

### BACKGROUND OF THE INVENTION

1. Field of the Invention

The present invention relates to touch display device technology, and in particular to layouts of traces for touch sensing electrodes of touch display devices which can prevent a visible moire effect.

2. Description of the Related Art

Along with developments in the electronics industry, various digital products, such as mobile phones, tablet computers, digital cameras and other electronic devices, have a requirement for touch functionality. Using touch screens on electronic products can provide faster and more convenient operation. Touch screens include a touch panel and a display panel. The touch panel is disposed above the display panel, such that the viewing area of the display panel is covered with a touch-sensitive surface. Touch screens are able to detect touch within the viewing area, such as detecting whether a finger or a stylus is present pressing a fixed-image button on the touch screen, and detecting the presence and position of a finger or a stylus on the touch screen.

Touch panels use various technologies to sense the touch of a finger or a stylus. These technologies employ resistive, capacitive, infrared or acoustic sensors. Currently, resistive-type and capacitive-type touch technologies are commonly used in touch panels. Resistive-type and capacitive-type touch panels often use transparent conductive materials to form touch sensing elements, so that the display images can be seen through the touch panel. However, the pattern, size and shape of the touch sensing elements of the touch panel which is disposed above and overlap with the display panel have an effect on the quality of the display image of the touch screen.

### BRIEF SUMMARY OF THE INVENTION

The disclosure provides touch display devices which can prevent a visible moire effect. The disclosure uses layouts of electrode connection traces of a touch sensing layer to prevent the visible moire effect which is produced by interference between the pattern of the electrode connection traces of the touch sensing layer and the pattern of the pixel array of the display element. Therefore, the touch display devices reduce the visible moire effect. The display image quality of the touch display devices is thereby improved.

In some embodiments of the disclosure, a touch display device is provided. The touch display device comprises a display element having a plurality of pixel areas and a touch sensing layer formed on a surface of a substrate of the display element. The touch sensing layer comprises a plurality of electrodes, a plurality of zigzag traces and a plurality of zigzag slits. Each of the zigzag traces is connected with one individual electrode. Each of the zigzag slits is disposed between two adjacent zigzag traces. The zigzag slits and the zigzag traces are alternately disposed with each other. The zigzag slits overlap with the pixel areas. The zigzag slits comprise a first slit, a second slit and a third slit. The second slit is between the first and third slits. Each of the zigzag slits has a plurality of turning points. The first distance is between a turning point of the second slit and the nearest adjacent turning point of the first slit. The second distance is between the turning point of the second slit and the nearest adjacent turning point of the third slit. The first distance is different from the second distance.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a cross section of a touch display device according to some embodiments;

FIG. 2 shows an illustrative plane view of a touch sensing layer of a touch display device according to some embodiments;

FIG. 3 shows a plane view of one pixel area of a touch display device according to some embodiments;

FIG. 4 shows a layout pattern of zigzag traces of a touch sensing layer of a touch display device which has a visible moire effect;

FIG. 5 shows a plane view to illustrate the overlapping relation between the zigzag traces of FIG. 4 and the positions of sub-pixel areas of a touch display device;

FIG. 6 shows a plane view to illustrate the offset of zigzag slits between zigzag traces of a touch sensing layer of a touch display device according to some embodiments;

FIGS. 7-9 show layout patterns of zigzag traces of touch sensing layers of touch display devices without a visible moire effect according to some embodiments;

FIG. 10 shows a plane view to illustrate the relative positions of several turning points of zigzag slits disposed between zigzag traces in a layout pattern of the zigzag traces of a touch sensing layer according to some embodiments; and

FIG. 11 shows a plane view to illustrate the shape of zigzag slits disposed between zigzag traces according to some embodiments.

### DETAILED DESCRIPTION OF THE INVENTION

The following description is the embodiments of carrying out the invention. This description is made for the purpose of illustrating the general principles of the invention and should not be taken in a limiting sense. The scope of the invention is best determined by reference to the appended claims.

Moreover, in the descriptions of the embodiments that follow, the orientations of “on”, “over”, “above”, “under” and “below” are used for representing the relationship between the relative positions of each element in the touch display devices, and not used to limit the present disclosure. In addition, a first element formed “on”, “over”, “above”, “under” or “below” a second element includes embodiments having the first element in direct contact with the second element, or embodiments having additional elements inserted between the first element and the second element so that the first element is not in direct contact with the second element.

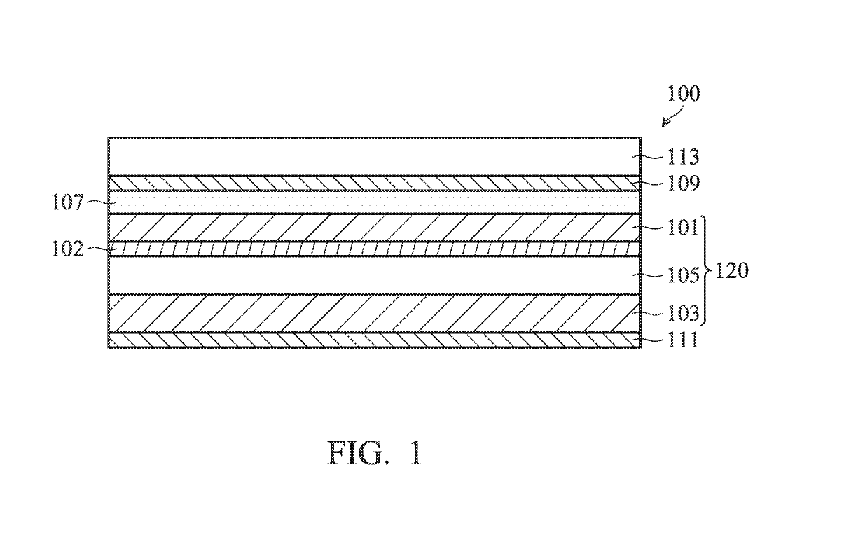

Referring to FIG. 1, a cross section of a touch display device 100 according to some embodiments is shown. The touch display device 100 can be formed by a touch-on-display (TOD) type touch panel which has touch sensors formed on a display element. The touch display device 100 comprises a display element 120. The display element 120 comprises a first substrate 101, a second substrate 103 and a display medium layer 105 sandwiched between the first substrate 101 and the second substrate 103. In some embodiments, the display element 120 is for example a liquid-crystal display panel. The first substrate 101 can be a color filter (CF) substrate which has a color filter layer 102 formed on an inside surface of the first substrate 101. The second substrate 103 can be a thin-film transistor (TFT) array substrate. The display medium layer 105 can be a liquid-crystal layer.

In addition, the touch display device 100 comprises a touch sensing layer 107 formed on an outside surface of the first substrate 101 of the display element 120. In some embodiments, the display element 120 may be a liquid-crystal display panel, so that the touch display device 100 further comprises a first polarizer 109 and a second polarizer 111, respectively, disposed above the touch sensing layer 107 and under the second substrate 103 of the display element 120. In other words, the first polarizer 109 and the second polarizer 111 sandwich the display element 120 and are disposed at the outside surfaces of the display element 120. The touch sensing layer 107 is disposed between the first polarizer 109 and the second polarizer 111. Moreover, the touch display device 100 further comprises a cover glass 113 disposed above the first polarizer 109. The above elements can be bonded together by adhesive layers to form the touch display device 100.

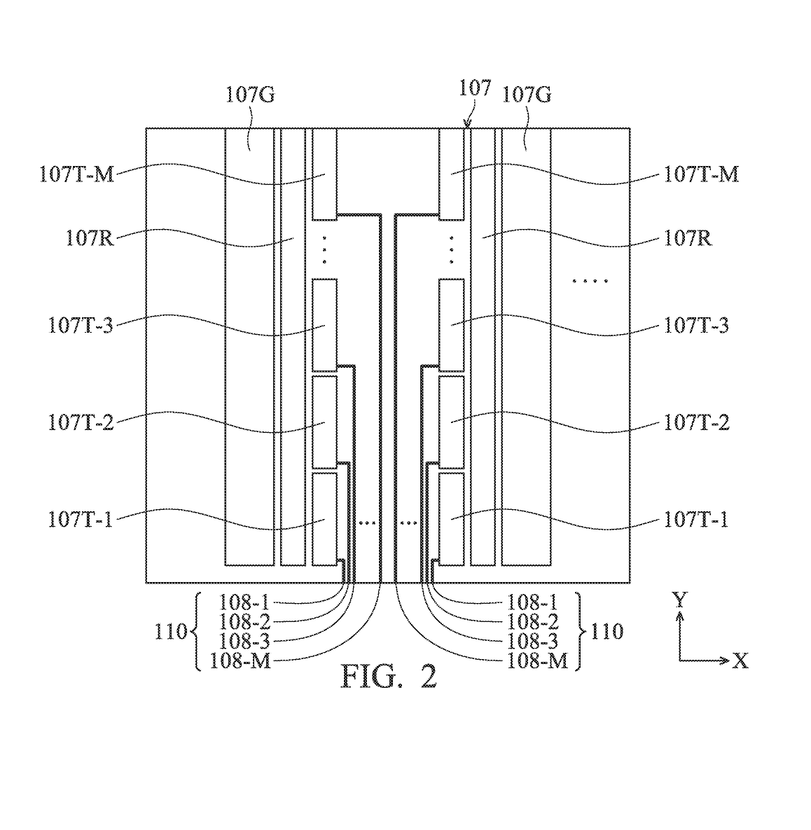

In some embodiments, the touch sensing layer 107 is formed by coplanar single layered capacitive-type touch sensors. FIG. 2 is a plane view of a touch sensing layer 107 of a touch display device 100 according to some embodiments. As shown in FIG. 2, the touch sensing layer 107 comprises a plurality of groups of touch sensing electrodes. Each group of touch sensing electrodes comprises a first electrode 107R which is continuous along an Y-axial direction and a plurality of second electrodes 107-1, 107-2, 107-3 to 107-M which are arranged in one column and are discontinuous along the Y-axial direction. The second electrodes 107-1 to 107-M have connecting traces 108-1, 108-2, 108-3 to 108-M, respectively. Two-dimensional touch signals can be detected through the first electrode 107R and the second electrodes 107-1, 107-2, 107-3 to 107-M.

A grounded electrode 107G can be disposed at the outside of the first electrode 107R. Moreover, some dummy patterns (not shown) can be disposed between the grounded electrode 107G and the first electrode 107R, and between the first electrode 107R and the second electrodes 107-1 to 107-M. The grounded electrode 107G and the dummy patterns can be formed by a conductive material, which is the same as that of the first electrode 107R and the second electrodes 107-1 to 107-M. The dummy patterns are not connected to any electric potential and have floating voltages.

The shape of electrodes of the touch sensing layer 107 is not limited to the rectangle of the first electrode 107R and the rectangles of the second electrodes 107-1, 107-2, 107-3 to 107-M. The shape of the electrodes as shown in FIG. 2 is illustrated to simplify the drawing and for easy description. In some other embodiments, the first electrode 107R and the second electrodes 107-1, 107-2, 107-3 to 107-M can have irregular polygonal shapes staggered with each other to form an interlocking pattern. Moreover, the shape of the connecting traces 108-1, 108-2, 108-3 to 108-M connected to the second electrodes 107-1 to 107-M is not limited to the straight line shown in FIG. 2. In some other embodiments, the connecting traces 108-1, 108-2, 108-3 to 108-M can be zigzag traces. The area of disposing the connecting traces 108-1, 108-2, 108-3 to 108-M can be referred to as a trace area 110. In the embodiments, the trace area 110 is disposed between two groups of second electrodes 107-1 to 107-M. There are two groups of connecting traces 108-1, 108-2, 108-3 to 108-M disposed in each trace area 110. In some other embodiments, the trace area 110 has other designs for the connecting traces 108-1, 108-2, 108-3 to 108-M.

As shown in FIG. 1 and FIG. 2, the area for disposing the first electrode 107R, the second electrodes 107-1 to 107-M, and the connecting traces 108-1 to 108-M connected to the second electrodes 107-1 to 107-M of the touch sensing layer 107 overlaps with the pixel areas of the display element 120. Moreover, the electrodes and the traces of the touch sensing layer 107 are disposed above the pixel areas of the display element 120. Although it is not shown in FIG. 2, the display element 120 actually comprises a plurality of pixel areas arranged into an array form.

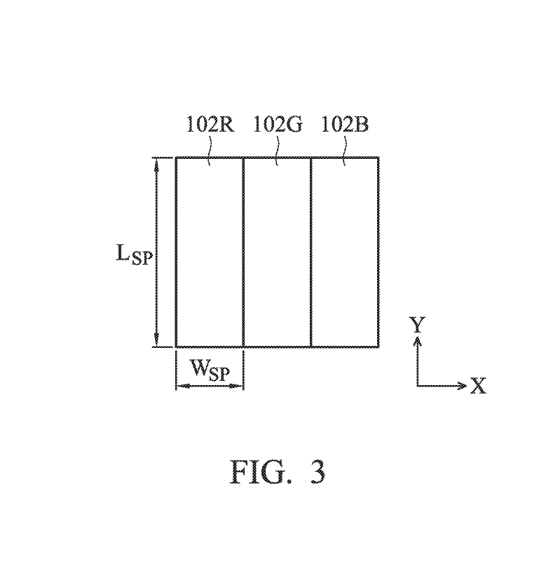

FIG. 3 is a plane view of one pixel area of a touch display device 100 according to some embodiments. As shown in FIG. 3, in some embodiments, one pixel area comprises three sub-pixel areas 102R, 102G and 102B. These sub-pixel areas 102R, 102G and 102B respectively have a red, a green and a blue color, so that the touch display device 100 has a color image display effect. Each sub-pixel area 102R, 102G or 102B has the horizontal width Wsp at an X-axial direction and the vertical length Lsp at a Y-axial direction. Moreover, the horizontal width Wsp of one sub-pixel area is equal to a third of the horizontal width of one pixel area. The vertical length Lsp of one sub-pixel area is equal to the vertical length of one pixel area.

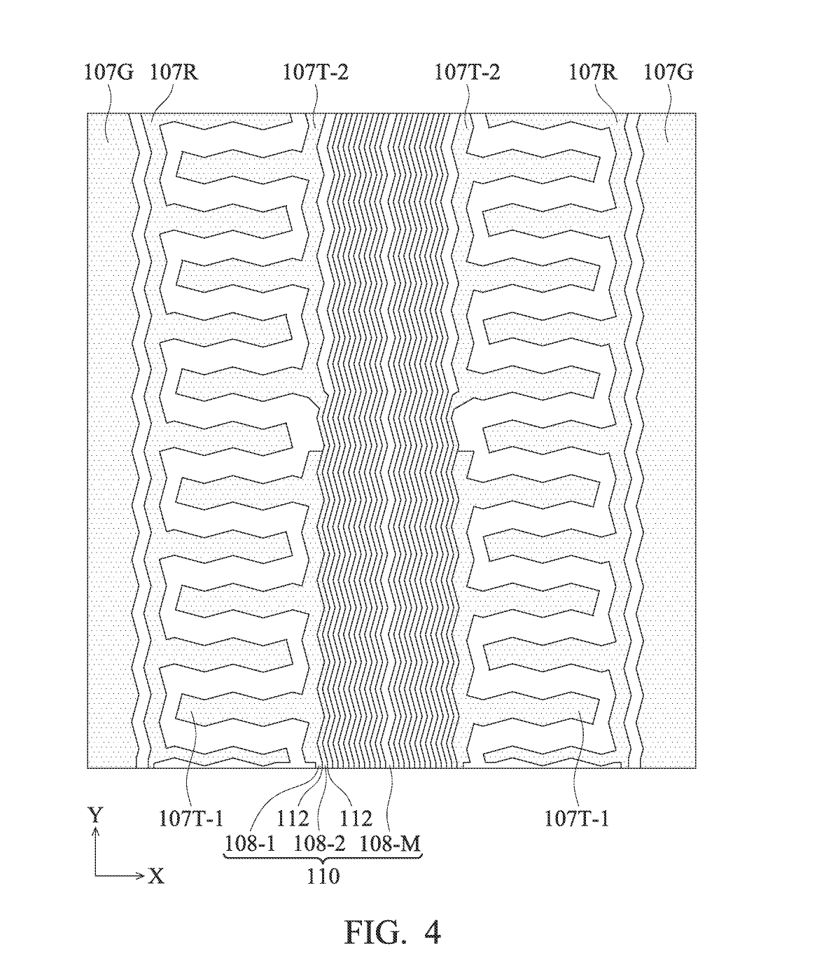

FIG. 4 is a layout pattern of zigzag traces of a touch sensing layer of a touch display device which has a visible moire effect. As shown in FIG. 4, these zigzag traces 108-1, 108-2, 108-3 to 108-M have the same line width and are arranged in an equal pitch. Therefore, zigzag slits 112 between the zigzag traces 108-1, 108-2, 108-3 to 108-M of FIG. 4 have a regular arrangement pattern. When the combination of the positions of the zigzag slits 112 and the arrangement of the sub-pixel areas having the same color has a regular and periodic arrangement, i.e., the pitch of the zigzag traces is almost equal to the horizontal width of one pixel area, the sub-pixel areas having the same color overlap with the slits. As a result, human eye can see the sub-pixel areas of the same color periodically appearing in the slits. Thus, the pattern of the zigzag traces will interfere with the pixel array pattern of the display element to produce a strip-shaped streak and cause the touch display device to have a visible moire effect.

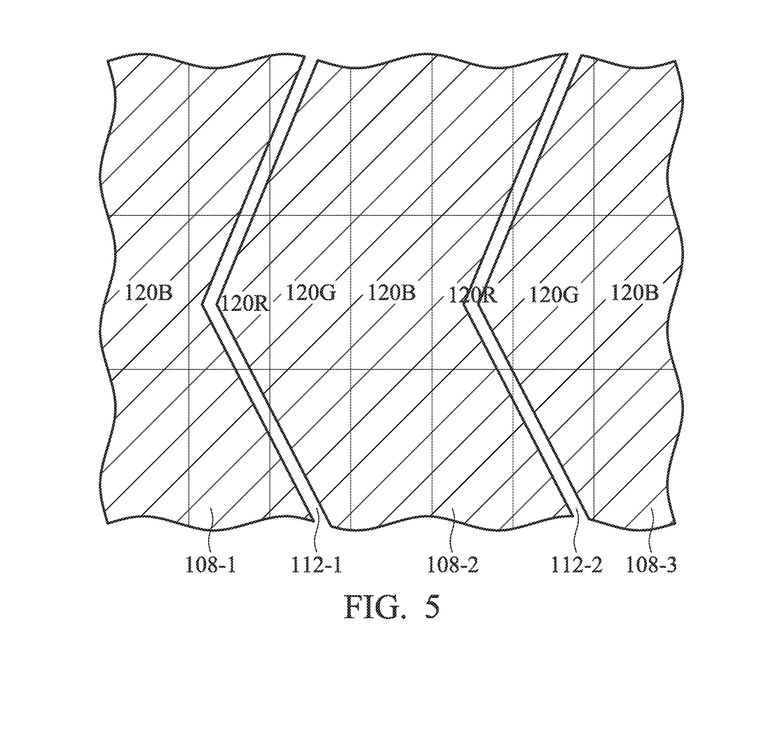

FIG. 5 is a plane view to illustrate the overlapping relation between the zigzag traces 108-1, 108-2 and 108-3 of FIG. 4 and the sub-pixel areas 102R, 102G and 102B. As shown in FIG. 5, when the zigzag slits 112 between the zigzag traces 108-1, 108-2 and 108-3 regularly correspond to the sub-pixel areas with the same color in the same row of the pixel areas, for example the red sub-pixel areas 102R in the same row of the pixel areas, the touch display device will appear to have red strip-shaped streaks. Moreover, the zigzag slits 112 further regularly correspond to the sub-pixel areas with the other colors, for example the green and blue sub-pixel areas 102G and 102B in the same row of the pixel areas, thus the touch display device further appears to have green and blue strip-shaped streaks. Because the human eye is sensitive to the periodically appearing patterns, the strip-shaped streaks, which can also be referred to as an interference moire, is easy to see and the image display quality of the touch display device is thereby reduced.

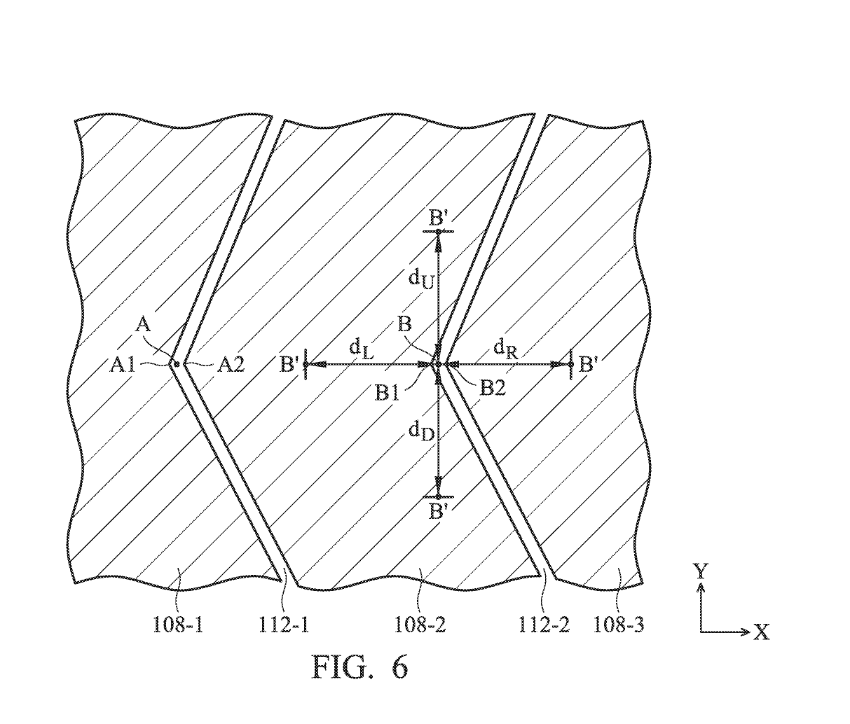

Referring to FIG. 6, a plane view to illustrate the adjustment of zigzag slits position offset between the zigzag traces of a touch sensing layer according to some embodiments is shown. Firstly, a pattern of a plurality of zigzag traces is provided. The zigzag traces are arranged in an equal pitch to form a first trace layout pattern. The first trace layout pattern is such as the trace layout pattern as shown in FIG. 4. In the first trace layout pattern, a plurality of zigzag slits 112-1 and 112-2 is between the zigzag traces 108-1, 108-2 and 108-3. The zigzag traces 108-1, 108-2 and 108-3 and the zigzag slits 112-1 and 112-2 are alternately arranged. Each of the zigzag slits 112-1 and 112-2 has a plurality of turning points, such as turning points A and B. For each turning point of each zigzag slit, a straight-line distance between a turning point of a zigzag slit and an adjacent turning point of an adjacent zigzag slit, for example between the turning point A of the slit 112-1 and the turning point B of the slit 112-2, is the same as that of another turning point A of the slit 112-1 and another turning point B of the slit 112-2. As shown in FIG. 6, the turning point A is a center point of a line between a point A1 and a point A2. The points A1 and A2 are two points at two edges of the slit 112-1 at a turning position. The points A1 and A2 are located at two sides of the turning point A. The turning point B is a center point of a line between a point B1 and a point B2. The points B1 and B2 are two points at two edges of the slit 112-2 at a turning position. The points B1 and B2 are located at two sides of the turning point B.

According to some embodiments of the disclosure, the position of each turning point of the zigzag slits is shifted by a distance. For example, the position of the turning point B may be shifted upward, downward, leftward or rightward by a distance d_{U}, d_{D}, d_{L} or d_{R}, so that the turning point B is shifted from the original position to the position of a turning point B′. According to some embodiments of the disclosure, the distances d_{L} and d_{R} of each turning point of the zigzag slits shifted at the horizontal direction, such as an X-axial direction, are greater than or equal to the horizontal width Wsp of one sub-pixel area of the display element (referring to FIG. 3 together), and the distances d_{L} and d_{R} are smaller than three times the horizontal width Wsp. In addition, the distances d_{U} and d_{D} of each turning point of the zigzag slits shifted at the vertical direction, such as a Y-axial direction, are greater than or equal to the vertical length Lsp of one sub-pixel area of the display element (referring to FIG. 3 together), and the distances d_{U} and d_{D} are smaller than three times the vertical length Lsp.

After the position of each turning point of the zigzag slits in the first trace layout pattern is adjusted to shift with a distance, a second trace layout pattern is produced. The second trace layout pattern has a plurality of zigzag traces arranged with an unequal pitch. Using the second trace layout pattern to perform a patterning process on a transparent conductive layer formed on the outside surface of the substrate 101 of the display element 120 can form a plurality of zigzag traces 108-1, 108-2 and 108-3 respectively connected to the second electrodes 107T-1 to 107T-M of the touch sensing layer 107. According to some embodiments of the disclosure, the zigzag traces formed by using the second trace layout pattern are arranged with unequal pitches. Thus, the positions of zigzag slits between the zigzag traces do not interfere with the sub-pixel areas having the same color in the pixel array of the display element. As a result, there is no strip-shaped streak produced in the touch display devices. Therefore, the touch display devices of the disclosure do not have a visible moire effect.

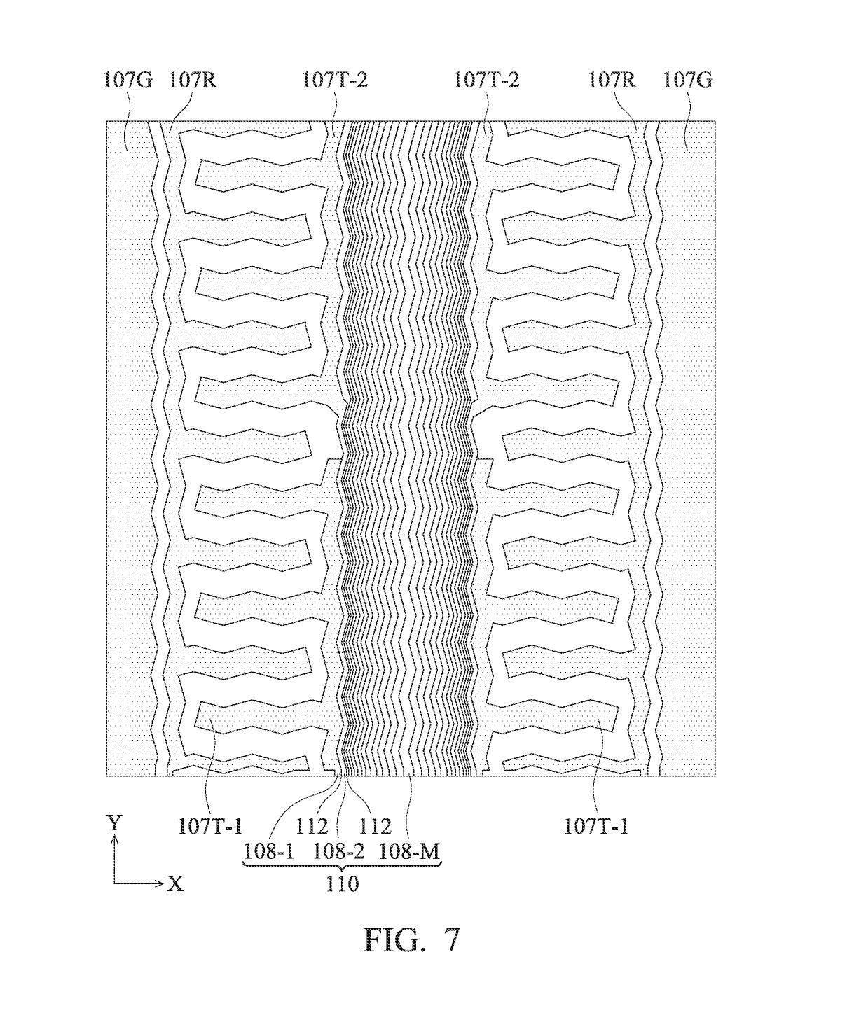

In an embodiment, the distance d_{L} or d_{R} of each turning point at the same zigzag slit shifting at the horizontal direction, such as an X-axial direction is the same as that of other turning points. Moreover, the horizontal shift distance of a zigzag slit, such as the distance d_{L} or d_{R} at the X-axial direction is different from that of the turning points of an adjacent zigzag slit. In addition, each turning point of the zigzag slits does not have a shift distance at the vertical direction, for example the Y-axial direction. Next, a second trace layout pattern formed by the turning point shifting adjustment of the embodiment is used to perform a patterning process on a transparent conductive layer formed on the outside surface of the substrate 101 of the display element 120. Then, a zigzag trace layout pattern of a touch sensing layer as shown in FIG. 7 is formed.

As shown in FIG. 7, the zigzag traces 108-1 to 108-M are arranged with unequal pitches. The adjacent zigzag traces have widths different from each other. The widths of the zigzag traces are gradually increased along the horizontal direction, such as an X-axial direction. The thinnest zigzag trace is nearest to the second electrodes 107T-1 to 107T-M. The widths of the zigzag traces are gradually widened while the zigzag traces are far from the second electrodes 107T-1 to 107T-M. In the embodiment, the zigzag slits 112 between the zigzag traces 108-1 to 108-M are also arranged with unequal pitches. Thus, the arrangement pattern of the zigzag slits 112 does not interfere with the arrangement pattern of the pixel array of the display element. As a result, there is no strip-shaped streak produced in the touch display devices. Therefore, the touch display devices of the disclosure can prevent a visible moire effect.

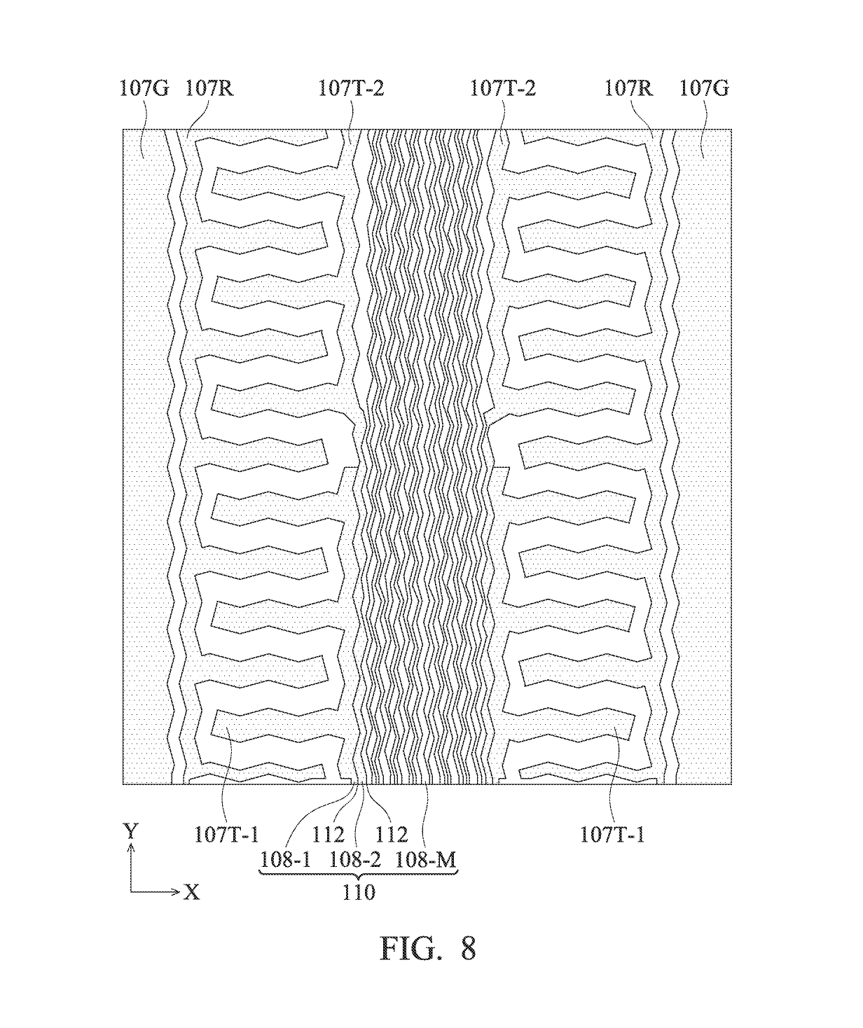

In some embodiments, a shift distance for each turning point at the same zigzag slit shifting at the vertical direction, such as the distance d_{U} or d_{D} at the Y-axial direction is the same as the distance d_{U} or d_{D} of other turning points of the same zigzag slit shifting at the Y-axial direction. Moreover, the vertical shift distances of the turning points of the zigzag slit, such as the distance d_{U} or d_{D} at the Y-axial direction is different from that of the turning points of an adjacent zigzag slit. In addition, each turning point of the zigzag slits has no shift distance at the horizontal direction, for example the X-axial direction. A second trace layout pattern is formed by the adjustment method of the embodiment for shifting the turning points of the zigzag slits. The second trace layout pattern is used to perform a patterning process on a transparent conductive layer formed on the outside surface of the substrate 101 of the display element 120. Then, a layout pattern of zigzag traces of a touch sensing layer as shown in FIG. 8 is formed.

As shown in FIG. 8, the zigzag traces 108-1 to 108-M are arranged with unequal pitches. The adjacent zigzag traces have widths different from each other. The widths of the zigzag traces are configured in narrow and wide alternately along the horizontal direction, such as an X-axial direction. In the embodiment, the zigzag slits 112 between the zigzag traces 108-1 to 108-M are also arranged with unequal pitches. Thus, the arrangement pattern of the zigzag slits 112 does not interfere with the arrangement pattern of the pixel array of the display element. As a result, there is no strip-shaped streak produced in the touch display devices. Therefore, the touch display devices of the disclosure can prevent a visible moire effect.

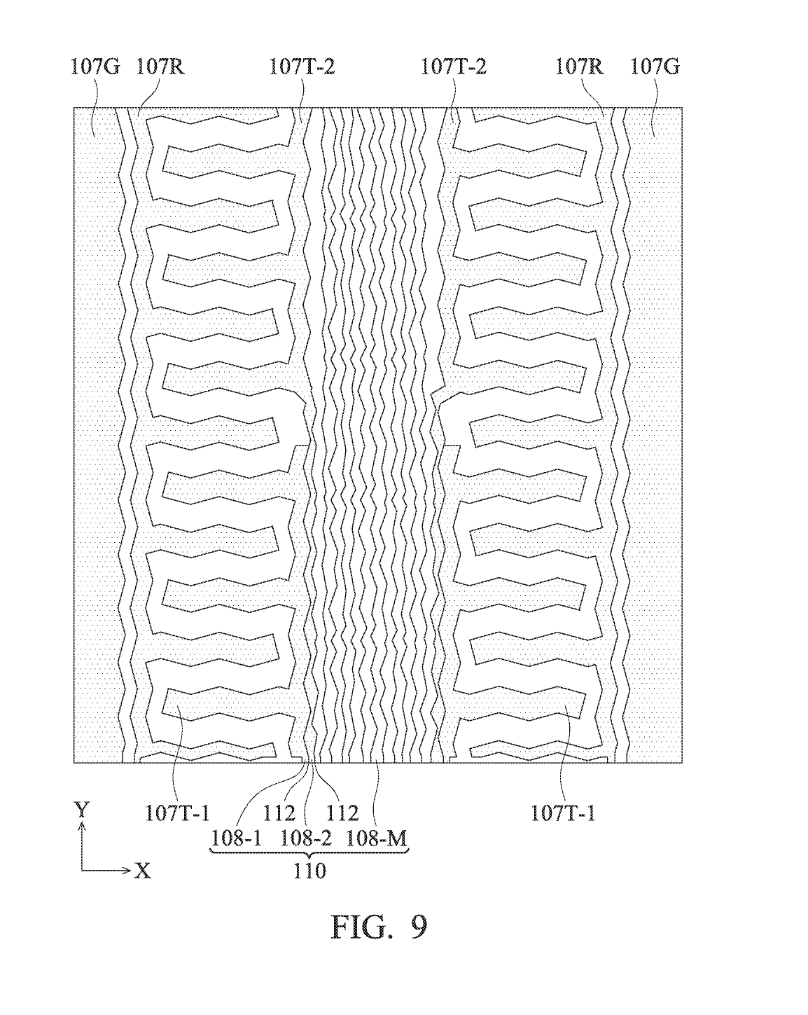

In some embodiments, any two adjacent turning points at the same zigzag slit have two different shift distances at the horizontal direction, such as an X-axial direction. In addition, any two adjacent turning points at the same zigzag slit have two different shift distances at the vertical direction, such as a Y-axial direction. Moreover, two adjacent turning points of any two adjacent slits have different shift distances at the horizontal direction, such as the X-axial direction. In addition, two adjacent turning points of any two adjacent slits have different shift distances at the vertical direction, such as the Y-axial direction. A second trace layout pattern is formed by the adjustment method of the embodiment for shifting the turning points of the zigzag slits. The second trace layout pattern is used to perform a patterning process on a transparent conductive layer formed on the outside surface of the substrate 101 of the display element 120. Then, a layout pattern of zigzag traces of a touch sensing layer as shown in FIG. 9 is formed.

As shown in FIG. 9, the zigzag traces 108-1 to 108-M are arranged with unequal pitches. The adjacent zigzag traces have widths that are different from each other. The widths of the zigzag traces are configured to randomly arrange with alternate narrow and wide widths along the horizontal direction, such as the X-axial direction. In the embodiment, the zigzag slits 112 between the zigzag traces 108-1 to 108-M are also arranged with unequal pitches. Thus, the arrangement pattern of the zigzag slits 112 does not interfere with the arrangement pattern of the pixel array of the display element. As a result, there is no strip-shaped streak produced in the touch display devices. Therefore, the touch display devices of the disclosure can prevent a visible moire effect.

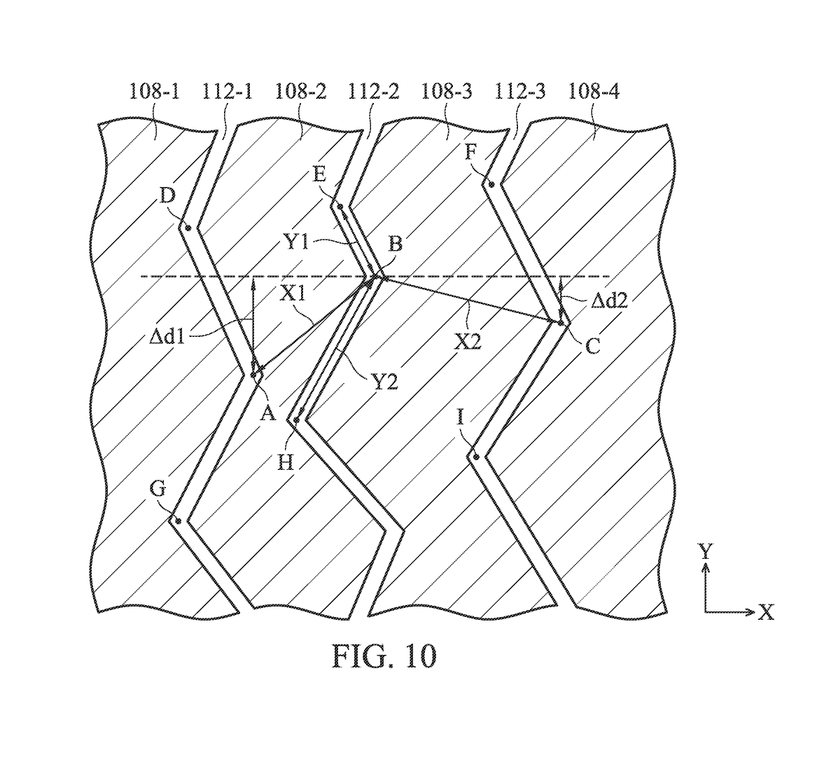

Referring to FIG. 10, a partial plane view of the relative positions of several turning points of the zigzag slits disposed between the zigzag traces according to some embodiments is shown. The partial plane view of FIG. 10 is used to illustrate the layout patterns of the zigzag traces of the touch sensing layers of FIGS. 7-9. As shown in FIG. 10, the layout patterns of the zigzag traces comprise a plurality of zigzag traces 108-1, 108-2, 108-3 and 108-4 and a plurality of zigzag slits 112-1, 112-2 and 112-3 arranged alternately. The zigzag slits 112-1, 112-2 and 112-3 can be referred to as a first slit 112-1, a second slit 112-2 and a third slit 112-3, respectively. The second slit 112-2 is disposed between the first slit 112-1 and the third slit 112-3. Each of the zigzag slits 112-1, 112-2 and 112-3 has a plurality of turning points, such as turning points A to I as shown in FIG. 10. The positions of the turning points A to I are located at the turns of the zigzag slits and at a central point between two ends of the slit.

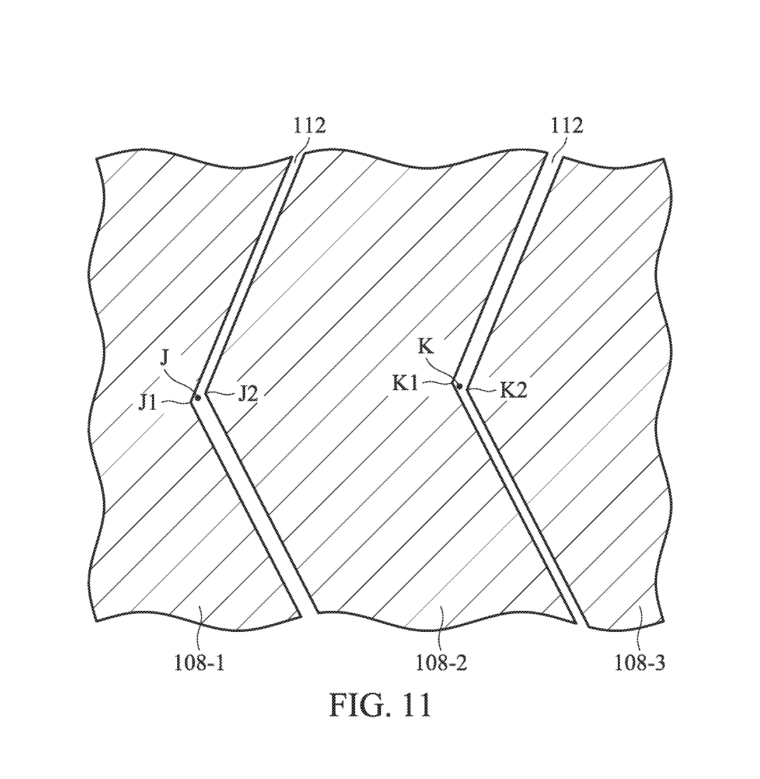

The zigzag slits 112-1, 112-2 and 112-3 as shown in FIG. 10 have an equal width. However, in some other embodiments, as shown in FIG. 11, the width of each zigzag slit 112 can be different from the widths of other zigzag slits 112. Moreover, each zigzag slit 112 can have different widths at different positions. In the embodiment of FIG. 11, for the zigzag slits 112 that have unequal widths at different positions, the positions of turning points J and K are also located at the turns of the zigzag slits 112. The turning point J is a central point of a line between two ends J1 and J2 of the slit 112. The points J1 and J2 are two points of two edges of the slit 112 at a turn. The points J1 and J2 are located at two sides of the turning point J. The turning point K is a center point of a line between two ends K1 and K2 of another slit 112. The points K1 and K2 are two points of two edges of the slit 112 at a turn. The points K1 and K2 are located at two sides of the turning point K.

As shown in FIG. 10, a first distance X1 is between the turning point B of the second slit 112-2 and an adjacent turning point A of the adjacent first slit 112-1. A second distance X2 is between the turning point B of the second slit 112-2 and an adjacent turning point C of the adjacent third slit 112-3.

According to some embodiments of the disclosure, in the layout patterns of the zigzag traces of the touch sensing layers as shown in FIGS. 7-9, the first distance X1 and the second distance X2 as shown in FIG. 10 for the layout patterns of FIGS. 7-9 are different from each other.

In addition, as shown in FIG. 10, a third distance Y1 and a fourth distance Y2 are respectively between any one turning point of each zigzag slit and two adjacent turning points at the same slit. For example, the third distance Y1 and the fourth distance Y2 are between the turning point B of the second zigzag slit 112-2 and two adjacent turning points E and H at the second zigzag slit 112-2 respectively.

According to some embodiments of the disclosure, in the layout patterns of the zigzag traces of the touch sensing layers as shown in FIGS. 7 and 8, the third distance Y1 and the fourth distance Y2 as shown in FIG. 10 for the layout patterns of FIGS. 7 and 8 are equal. In addition, in the layout pattern of the zigzag traces of the touch sensing layer as shown in FIG. 9, the third distance Y1 and the fourth distance Y2 as shown in FIG. 10 for the layout pattern of FIG. 9 are different.

Moreover, in the layout pattern of the zigzag traces of the touch sensing layer as shown in FIG. 7, the turning points A to I of the first slit 112-1, the second slit 112-2 and the third slit 112-3 are aligned to each other at the same horizontal line that is vertical to the slits 112-1 to 112-3 and without a shift in the vertical direction. In other words, in the embodiment of FIG. 7, each turning point of each zigzag slit is aligned with each other at the horizontal line, for example the X-axial direction, and without shift at the vertical direction for example the Y-axial direction.

In addition, in the layout patterns of the zigzag traces of the touch sensing layers as shown in FIGS. 8 and 9, the turning points A to I of the first slit 112-1, the second slit 112-2 and the third slit 112-3 are not aligned to each other at the same horizontal line that is vertical to the slits 112-1 to 112-3. The turning points A to I shift at the vertical direction. As shown in FIG. 10, the turning point A of the first slit 112-1 has a first vertical offset Δd1 relative to the adjacent turning point B of the second slit 112-2. The turning point C of the third slit 112-3 has a second vertical offset Δd2 relative to the turning point B of the second slit 112-2.

According to some embodiments of the disclosure, in the layout patterns of the zigzag traces of the touch sensing layers as shown in FIGS. 8 and 9, the first vertical offset Δd1 is different from the second vertical offset Δd2. According to some embodiments of the disclosure, in the layout pattern of the zigzag traces of the touch sensing layers as shown in FIG. 8, the first vertical offset Δd1 can be equal to the second vertical offset Δd2.

In some embodiments of the disclosure, the pixel array of the display element of the touch display devices comprises a plurality of pixel areas. Each pixel area comprises several sub-pixel areas with different colors. The sub-pixel areas having the same colors in the pixel array are arranged into a regular pattern. The layout pattern of the zigzag traces of the touch sensing layer of the touch display devices is an irregular pattern. Thus, the zigzag slits between the zigzag traces are also arranged into an irregular pattern. As a result, the layout pattern of the touch sensing layer does not interfere with the pattern of the pixel array of the display element. Therefore, the touch display devices do not have a visible moire effect.

In summary, according to some embodiments of the disclosure, the positions of the turning points of the zigzag slits between the zigzag traces of the touch sensing layer are adjusted by shifting. As a result, the zigzag traces of the touch sensing layer are arranged into layout patterns with unequal pitches. The layout patterns of the zigzag traces which have unequal pitches do not interfere with the layout patterns of the pixel array of the display element which have equal pitch. Therefore, there is no strip-shaped streak in the touch display devices. The touch display devices of the disclosure can prevent a visible moire effect and the image display quality of the touch display devices is thereby enhanced.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A touch display device, comprising:
a display element having a plurality of pixel areas; and
a touch sensing layer disposed on a surface of a substrate of the display element, wherein the touch sensing layer comprises:
a plurality of electrodes; and
a plurality of zigzag traces and a plurality of zigzag slits, wherein each of the zigzag traces is connected with one of the electrode, each of the zigzag slits is disposed between two adjacent zigzag traces, and the zigzag slits and the zigzag traces are alternately disposed with each other, and
wherein the zigzag slits overlap with the pixel areas, the zigzag slits comprise a first slit, a second slit and a third slit, the second slit is between the first and third slits, the first slit, the second slit and the third slit each has a plurality of turning points, a first distance is between a turning point of the second slit and a nearest adjacent turning point of the first slit, a second distance is between the turning point of the second slit and a nearest adjacent turning point of the third slit, and the first distance is different from the second distance.

2. The touch display device of claim 1, wherein there are a third distance and a fourth distance respectively between a turning point of each zigzag slit and two adjacent turning points of the same zigzag slit, and the third distance is the same as the fourth distance.

3. The touch display device of claim 1, further comprising a first polarizer and a second polarizer sandwiching the display element, wherein the touch sensing layer is disposed between the first polarizer and the second polarizer.

4. The touch display device of claim 1, wherein the zigzag trace has a width that is different from that of the adjacent zigzag traces, the widths of the zigzag traces are gradually increased along a direction vertical to the direction of the zigzag traces, and the zigzag traces are disposed by unequal pitches.

5. The touch display device of claim 2, wherein the turning point of the second slit has a first vertical offset to the nearest adjacent turning point of the first slit, the turning point of the second slit has a second vertical offset to the nearest adjacent turning point of the third slit, and the first vertical offset is different from the second vertical offset.

6. The touch display device of claim 5, wherein the zigzag trace has a width different from that of the adjacent zigzag traces, the widths of the zigzag traces are narrow and wide alternately along a direction vertical to the direction of the zigzag traces, and the zigzag traces are disposed by unequal pitches.

7. The touch display device of claim 1, wherein a third distance and a fourth distance are respectively between a turning point of each zigzag slit and two adjacent turning points of the same zigzag slit, and the third distance is different from the fourth distance.

8. The touch display device of claim 7, wherein the zigzag trace has a width different from that of the adjacent zigzag traces, the widths of the zigzag traces are configured to randomly arrange with alternate narrow and wide widths along a direction vertical to the direction of the zigzag traces, and the zigzag traces are disposed by unequal pitches.

9. The touch display device of claim 1, wherein each pixel area comprises a portions overlapping with the sub-pixel areas of the same color in the pixel areas, and the portions of the zigzag slits constitute a non-strip shaped random pattern.

10. The touch display device of claim 1, wherein the electrodes and the zigzag traces of the touch sensing layer are formed from a transparent conductive layer.
